(19) United States
(12) Patent Application Publication
(10) Pub. No.: US 2025/0102073 A1
(43) Pub. Date: Mar. 27, 2025

(54) DEVICE FOR CONTROLLING PASSAGE OF FLUID

(71) Applicant: BHDT Gmbh, Kapfenberg (AT)

(72) Inventors: Alessandro BRUN, Graz (AT); Michael SIMML, Unterpremstätten (AT); Paul Maria Gerardus Clemens Petrus Hubertus JORISSEN, Landgraaf (NL); Alexander Aleida Antonius SCHEERDER, Roosteren (NL); Kirk Anguah OFEI, Eindhoven (NL)

(73) Assignee: BHDT Gmbh, Kapfenberg (AT)

(21) Appl. No.: 18/850,936

(22) PCT Filed: Mar. 28, 2023
(86) PCT No.: PCT/EP2023/058043

§ 371 Date: Sep. 25, 2024

(30) Foreign Application Priority Data
Mar. 28, 2022 (EP) 22164872.8

(51) Int. Cl. F16K 27/02; F16K 1/38; F16K 1/42; F16K 25/00; F16K 25/04

(52) U.S. Cl. CPC F16K 27/0254; F16K 1/38; F16K 1/427; F16K 25/005; F16K 25/04

(57) ABSTRACT

A valve (1) for regulating fluid flow comprising a valve body (2), an inlet for fluid, an outlet for fluid, a flow-regulating member (8), a chamber (7) for receiving fluid in the valve body, and a valve seat (21), wherein the valve body comprises an outer body part (4) and an inner body part (3) fit together and/or mechanically joined to each other, whereby the outer body part is made of a first material and whereby the inner body part is made of a second material, wherein the first and second material are different from each other; wherein the inner body part comprises a surface exposed to said chamber and directly in contact with said fluid in the chamber in operation.

### FIELD

The invention relates to a device and the use thereof for controlling the passage of fluid, whereby different parts of the device are made of different materials. The device is for instance a valve.

### INTRODUCTION

A valve is a device that regulates, directs or controls the flow of a fluid (gases, liquids, fluidized solids, or slurries) by opening, closing, or partially obstructing various channels. In an open valve, fluid flows in a direction from higher pressure to lower pressure.

There is a desire for highly corrosion resistant valves for use e.g. in chemical plants. These valves are in operation in contact with highly corrosive process fluids. Specifically, there is a desire for valve capable of regulating high pressure (e.g. above 100 bar), high temperature (e.g. above 100° C.) and highly corrosive fluids (in particular liquids), wherein the valves have a long lifetime and with low maintenance costs, and low capital costs. The present disclosure aims to provide a valve addressing one or more of these desires.

U.S. Pat. No. 3,913,610 describes a butterfly valve including a tubular sleeve member formed of a relatively high-strength metal; the sleeve member is also provided with an internal resilient lining.

U.S. Pat. No. 4,161,187 describes a control valve for regulating flow of erosive fluids. The valve has an outer body made of stainless steel and an inner body composed of three sleeves formed of chromium carbide or tungsten carbide. The valve plug and seat are also formed of such carbide.

U.S. Pat. No. 4,356,612 describes an improved forged steel structure, such as a valve, lined with a corrosion resistant metal in which the lining and body are forged together.

There remains a desire for improved valves.

### SUMMARY

The invention pertains in a first aspect to a valve for regulating fluid flow comprising a valve body, an inlet for fluid, an outlet for fluid, a flow-regulating member, a chamber for receiving fluid arranged in the valve body, and a valve seat, wherein the valve body comprises an outer body part and an inner body part fit together and/or mechanically joined to each other, whereby preferably the outer body part is made of a first material and whereby the inner body part is made of a second material, wherein the first and second material are preferably different from each other; wherein the inner body part preferably comprises a surface exposed to said chamber and directly in contact with said fluid in the chamber in operation.

The invention also provides use of such a valve for regulating fluid flow. The invention also provides a method of regulating fluid flow, comprising passing fluid through such a valve.

### BRIEF DESCRIPTION OF THE DRAWINGS

FIG. 1 schematically illustrates an example valve according to the invention.

FIGS. 2-6 illustrate different views of an example valve according to the invention.

Any embodiments illustrated in the figures are examples only and do not limit the invention.

### DETAILED DESCRIPTION

Advantageously in the inventive valve, the outer body part is not in direct contact with fluids in the chamber, and needs not be made of corrosion resistant material even if the fluids in the chamber are corrosive. Thereby a less expensive material can be used for the outer body part.

The valve is particularly useful for chemical plants, in particular for regulating the flow of fluids (such as liquid and/or gas) that are very aggressive. Moreover, the valve is very suitable for regulating the flow of fluids with a high pressure, such as more than 50 bar, more than 100 bar or even more than 150 bar. The valve is for instance configured for regulating the flow of fluids with a pressure of more than 50 bar, more than 100 bar or even more than 150 bar (absolute). The valve is also very suitable for regulating the flow of fluids with a temperature of above 100° or above 150° C., which fluids are for instance in said high pressure range and/or highly corrosive. In the use and method of the invention, such fluids are for example used.

Advantageously, the inner body part can be made of duplex stainless steel with good corrosion resistance properties and mechanical properties, by virtue of the relatively small size of the inner body part compared to an equivalent valve body made as a single piece.

The use of an inner body part and outer body part which are fit together and/or mechanically joined, e.g. connected, to each other, provides the advantage that relatively complex shapes can be achieved for the chamber which receives fluid in operation. This provides an advantage e.g. over lining. Preferably, the inner body part is releasably or detachably held in the outer body part by virtue of the inner and outer body part being fit together and/or mechanically joined to each other. Preferably, if the inner and outer body part are mechanically joined to each other, releasable connection means are used for connecting the inner and outer body part.

A lining process involves applying on the internal equipment surfaces in contact with the media (surfaces to be protected against corrosion) a thin layer of a suitable material, such as PTFE; typically a polymeric material. The lining process is generally not applicable for valves due to several limitations including the maximum allowable temperature being too close to the operating temperatures in chemical plants such as a HP section of a urea plant. The lining material is a soft thermoplastic material that cannot guarantee a proper lifetime against erosion, corrosion and/or cavitation. The lining material is a soft thermoplastic material that cannot guarantee a proper lifetime against the high pressure involved (e.g. at least 100 bar). Cladding with duplex stainless steel by welding is generally not an attractive option for valve bodies due to the complex internal geometry of the valve body. Moreover, unavoidable micro porosity can jeopardize valve functionality.

The inner body part can be made of highly corrosion resistant steel such as, e.g. duplex stainless steel.

The invention relates to a device for controlling the passage of fluid, whereby different parts of the device are preferably made of different materials. The device is for instance a valve.

The invention also pertains to the use of the device for controlling the passage of fluids, in particular for the use of the device, such as the valve, for regulating the flow of fluids that are highly corrosive and/or have pressure of more than 50 bar, more than 100 bar or even more than 150 bar and/or a temperature of more than 100° C. or more than 150° C.

The valve generally can be used for stopping and starting fluid flow, or varying the amount of fluid flow, or for example controlling the direction of fluid flow, or for example relieving over pressure. The valve can also be referred to as a device for controlling passage of fluid or a device for regulating fluid flow.

The valve body, which may also be referred to as the valve shell, is the primary pressure boundary of the valve. The valve body holds the elements of the valve together. The valve body in operation resists fluid pressure loads from connecting pipes. The valve body receives inlet and outlet piping through joints. The valve body typically contains an opening for assembly of the valve; in particular for assembly of flow regulating internal elements with the valve body.

The valve comprises a first opening and a second opening in the valve body for fluid to enter and exit the valve body. The openings are in particular configured for allowing the fluid to enter and exit the chamber for holding fluid, wherein said chamber is provided in the valve body. The valve hence comprises an inlet and an outlet. The valve may comprise two or more inlets and may comprise two or more outlets.

The valve also comprises a flow-regulating member, i.e. a flow-regulating internal element, for example a regulating stem or a disc. The flow regulating member can move in the chamber between at least two different positions for regulating the fluid flow. The flow regulating member is located in the chamber. The valve typically comprises a stem connecting the flow regulating member to a controlling device, such as an actuator or a handle. The flow regulating member is e.g. a plug and is for instance a pressure retaining part. The flow regulating member is, typically, a movable obstruction inside the valve body that adjustably restricts fluid flow through the valve. The flow regulating member is typically capable of being moved to a position wherein a passageway or port of the valve is obstructed in order to regulate the fluid flow. The flow regulating member is also known as disc; the flow regulating member may have various shapes.

The valve for example comprises a valve seat, providing a seating surface for the flow regulating member. The seat can be a surface of the valve body, but is preferably an element of the valve that is separate from the valve body. Hence, the valve body (inner body especially) and the valve seat are preferably distinct and separate elements. The valve seat for example provides an interior surface of the valve body which contacts the flow regulating member to form a leak-tight seal in at least one position of the flow regulating member.

The flow regulating member is for example connected by a stem to controlling device such as an actuator. The actuator is e.g. located outside the valve body. The stem for instance transmits motion from a handle or actuator to the flow regulating member. The actuator is for instance a controlling device of the valve and e.g. comprises a motor.

The valve typically comprises a removable piece making assembly of the valve possible, in particular assembly of the inner body part in the recess of the outer body part. In some embodiments, this piece is provided by the valve seat and the seat connection piece. The removable piece is jointed to the valve body e.g. with bolts. The removable piece may comprise an opening for fluid flow and may be connected to a pipe.

The valve for example has a valve body size of 4 inch (10.2 cm) or higher, such as 8 inch (20.3 cm) or higher. The valve for example has a nominal bore diameter of 70 mm or higher, such as 142 mm or higher and/or the valve for example has a seat diameter of 10 mm or higher, or 100 mm or higher, for instance 170 mm or higher.

The valve body comprises a chamber for receiving fluids. In the valve of the present disclosure, the inner body part provides the chamber. The walls of the chamber are provided by the inner body part. In particular, the walls of the chamber are provided only by the inner body part and not by the outer body part. The chamber is comprised in the inner body part.

The valve is for instance, without restriction, an angle type globe valve, a straight type globe valve, a butterfly valve, or a check valve. The angle type globe valve is e.g. a control valve or an on-off valve. The straight type globe valve is e.g. a control valve or an on-off valve. The butterfly valve is e.g. a control valve or an on-off valve.

The valve for instance comprises a movable plug or disc element and a stationary valve seat. The plug typically can be moved in the chamber configured for receiving fluids in the body.

The valve seat provides a stable, uniform and typically replaceable shut off surface. The valve seat is for instance a ring seat.

The valve is for instance, without restriction, designed to withstand at least 50 bar gauge or at least 100 bar gauge pressure, or at least 240 bar gauge, with the high pressure fluid inside.

The valve body comprises the inner and the outer body part. The inner and outer body part are fit together and/or mechanically joined to each other. Hence, the inner body part and outer body part are disjoint parts.

The inner body part is for example mechanically held in the outer body part, in particular in a recess of the outer body part. The inner body part is for instance fitted in a recess of the outer body part. In this way, the inner and outer body part can be fit together. For example, an interference fit or friction fit is used. The inner and outer body part are for example mechanically attached to each other. The inner body part is typically mechanically held in place in the outer body part, for example by a seat connection piece. The foregoing provides illustrative examples of the inner and outer body parts being mechanically joined to each other. An interference fit and friction fit are suitable for releasably holding the inner body part in place in a recess of the outer body part. The inner body part and outer body part preferably each rigid bodies, more preferably disjoint metal parts.

Typically, the inner body part is releasably held in place in the outer body part, e.g. detachably held. The outer body part typically includes a recess for receiving the inner body part in particular for assembly of the valve and preferably also disassembly of the valve. The valve body may comprise a crevice between the inner body part and outer body part, i.e. the inner body part and outer body part are disjoint parts. The valve body may also comprise a sealing element for said crevice. In embodiments wherein the inner body part can be released from the outer body part, advantageously the inner body part can be selectively replaced or exchanged for the purposes of maintenance and to mitigate any wear, corrosion, or erosion caused by the process fluid in the chamber.

Hence, preferably the outer body part has a recess for receiving the inner body part, more in particular for receiving and releasably holding the inner body part. In such embodiment, the inner body part can move out of the outer body part, e.g. slide out of the outer body part.

Preferably the outer body part is made of a first material and the inner body part is made of a second material, wherein the first and second material are different from each other. This advantageously may allow for lower manufacturing costs.

The inner body part comprises a surface exposed to said chamber, i.e. providing a boundary of said chamber, and directly in contact with said fluid in the chamber in operation. Preferably the inner body part is in part exposed to said chamber and is in part in direct contact with the fluid in operation.

The outer body part is for instance, without restriction, made of carbon steel, duplex stainless steel or austenitic stainless steel. In an interesting embodiment, the outer body part is made of carbon steel. Other materials are also possible, such as duplex stainless steel. However, the outer body part is in some embodiments made of material other than a duplex stainless steel. Use of a material other than a duplex stainless steel may be advantageous, firstly in view of the high content of expensive alloying elements in highly corrosion resistant duplex stainless steel and secondly, optionally, because of the need to control the micro structure of the duplex steel which may be challenging for larger equipment parts.

The outer body part is for instance made of carbon steel, austenitic stainless steel, and/or of stainless steel containing max. 27.0 wt. % Cr, e.g. containing 10.0-27.0 wt. % Cr, for instance stainless steel containing 10.0-25.0 wt. % Cr or e.g. containing 17.0-25.0 wt. % Cr.

The outer body part has for instance a wall thickness of at least 10 mm or at least 20 mm or at least 100 mm or at least 300 mm. Thereby the outer body part typically contributes to the mechanical strength of the valve.

The valve is configured to ensure that the outer body part is not in contact with the corrosive process fluid in operation.

The outer body part is for instance a single (unitary) metal piece. This is especially advantageously for high pressure valves.

The outer body part comprises for instance a recess for holding the inner body part and at least two openings providing a passageway for fluid. Typically, the valve comprises, for each of said openings, a hollow element extending through said opening, such that fluid can flow to and from the chamber through said openings, in particular through said element, without direct contact with the outer body part. The element is for instance tubular. At least one of said hollow elements may be provided by the inner body part.

Typically the outer body part also comprises an opening through which the stem of the flow regulating member extends. For example the outer body part comprises an opening through which a part of the inner body part extends, wherein said part of the inner body part comprises the stem packing. Preferably the valve body comprises two separate passageways or ports for fluid from and to the chamber, wherein said passageways both extend through the inner body part and the outer body part.

The inner body part is in operation in direct contact with the process fluid. The inner body part comprises a chamber and has a surface directly exposed to said chamber; said chamber receives the process fluid in operation. The chamber has for instance a concave and curved inner surface.

In some embodiments, the surface of the chamber is preferably curved and double concave, i.e. concave in two orthogonal directions, over at least 50% of said surface, as illustrated in FIG. 2 and FIG. 5. This may contribute to an advantageous fluid flow pattern in the chamber, with e.g. less erosion, especially for high pressure liquids. For manufacturing the inner body part, especially as a unitary part, with such a complex shape of the chamber, (duplex) stainless steel is advantageous.

Preferably, the parts of the inner body part providing the wall of the chamber, are entirely fitted in a recess of the outer body part in the assembled valve body.

The inner body part is for instance made of a corrosion resistant material, for instance made of a stainless steel, for example a duplex stainless steel.

In embodiments wherein the inner body part is made of a duplex stainless steel, the outer body part is preferably made of carbon steel. Advantageously the inner and outer body parts may have substantially the same thermal coefficient of expansion in such embodiments (e.g. less than 20% or less than 10% difference, relative to the thermal coefficient of expansion of the outer body part). This embodiment is especially advantageously for high temperature fluids, in particular liquids, supplied to the valve (e.g. above 100° C. or above 150° C.).

The inner body part is for instance a sleeve that fits in the outer body part and for example fits through an opening in the outer body part. The outer body part for instance comprises a recess for receiving the inner body part. This embodiment is especially advantageous when a high pressure fluid, in particular liquid, is supplied to the valve. Preferably in this embodiment the inner body part is releasably held in place in the outer body part. The sleeve is, for example, a tubular sleeve provided as a single unitary metal piece having an outer diameter that is smaller than the inner diameter of the (cylindrically shaped) recess of the outer body part, wherein said outer body part is a singly unitary metal piece.

The inner body part is for instance provided as one part, as two parts, or for example as three or more parts, and is preferably a sleeve provided in one or more parts. Optionally the inner body part is a single unitary part. Optionally the inner body part is a monolithic part.

Providing the inner body part is a single unitary part, more preferably made of duplex stainless steel, avoids the risk of crevice corrosion, compared to inner body parts made of two or more pieces. Moreover, in this embodiment the crevice between the inner and outer body part is less exposed to process fluid compared to embodiments with an inner body part provided as two or more parts, because the crevice between the inner body part can be completely shielded by the single unitary inner body part compared to an inner body part provided as two or more parts having crevices between them which crevices provide access for the fluid in the chamber to the outer body part. This is especially advantageous if the outer body part is made of carbon steel and susceptible to corrosion by the fluid in the chamber.

The inner and outer body part are preferably fit together. The inner and outer body part are for example connected to each other, for instance by mechanical connecting elements, such as pins, or bolting components. The inner body part is held in place in the outer body part. The inner and outer body part can also be mechanically joined by interference fit. For example the seat connection piece may lock the inner body part in place. It may be observed that the mentioned connection means are suitable for releasably connecting the inner and outer body parts.

The inner and outer body part together form the valve body. The inner body part comprises the chamber and comprises at least two openings for fluid and typically also an opening for the stem.

The valve optionally comprises an O-ring and/or sealing element between the inner and outer body part, for example to prevent external fluids to enter the crevice between the inner and outer body part.

The valve typically comprises for instance a sealing element between the inner body part and the valve seat. The sealing element may also be arranged simultaneously between the protective element and the inner body part.

In embodiments wherein the inner body part consists of two or more parts, the valve optionally comprises for instance an O-ring and/or sealing element between the parts of the inner body part. The one or more sealing elements are e.g. a sealing ring or a metal-to-metal sealing. The sealing element is made e.g. of PTFE, PEEK, or is e.g. a metal sealing. Other types of non-metal sealings are also possible.

The valve for example also comprises a leak detection element. The leak detection element is optional and is a provision for detecting any leakage of fluid, in particular process fluid, from the inner body part towards the outer body part.

The valve seat is preferably releasably joined to the valve body. The valve seat preferably can be replaced for maintenance. The valve seat is preferably mechanically and releasably joined to the inner body part. In an example embodiment, the valve seat is supported by the inner body part. The valve seat is for example in direct contact with the inner body part. The valve seat and the inner body part are preferably separate equipment pieces; in particular disjoint parts. This provides the advantage that the valve seat can be replaced independently.

The valve seat is for example made of duplex stainless steel, with the same preferred alloys as for the internal body part. The valve seat is typically configured for contact with the flow regulating member, for example the plug, when the valve is in a closed position for sealing off the valve.

The valve seat optionally includes a notch prolongation. This prolongation advantageously contributes to the proper fitting with the plug. The valve seat for example includes a prolongation with a mating surface for engaging with the plug.

The valve for example comprises a seat connection piece. The seat connection piece is for example configured for holding the valve seat in place in the valve body. The seat connection piece is, for example, also configured for attachment of a tube or pipe to the valve. The seat connection piece is for example attached or joined to the outer body part by preferably releasable connecting means, such as stud bolts; e.g. detachable connecting means. The inner body part is preferably in direct contact with the seat connection piece, for instance with a threaded flange. The seat connection piece can be removed from the valve body to allow for replacement of the valve seat and/or the flow regulating member, such as the stem with plug. The seat connection piece is for example made of duplex stainless steel. The same materials are preferred as for the inner body part. The seat connection piece is for instance a tubular piece having one end provided with means for connecting with a pipe, such as a flange, and at the other end fitted in an opening of the inner body part and in direct contact with the valve seat. The seat connection piece is for example configured for holding the inner body part in place in a recess of the outer body part. The seat connection piece is typically configured for holding the valve seat in place in the valve body. For example the inner body part and the seat connection piece together provide a recess in which the valve seat fits, thereby holding the valve seat in place. The seat connection piece thereby is typically a pressure bearing part.

Removing the seat connection piece from the valve body may allow for removing the inner body part from the outer body part, in embodiments wherein the inner body part is releasably held in the outer body part. This can be used e.g. for replacement or inspection of the inner body part.

The valve in some embodiments comprises, as flow regulating member, a regulating stem and/or a stem and plug. The regulating stem may comprise a stem and plug. The plug can be moved through the chamber by the stem.

The valve comprises for example a regulating stem or a stem and a plug arranged for moving in the chamber between at least an opened position and a closed position. The plug is for example in contact with the valve seat in the closed position. The stem at one end extends through an opening in the wall of the valve. The stem preferably is provided with the plug at one end of the stem and at the other end the stem extends through an opening in the wall of the valve. For example the stem and plug are a unitary piece, or for example the stem and plug are welded together. The stem and plug are preferably both made of duplex stainless steel or other corrosion resistant stainless steels.

Optionally the stem extends through an opening provided only in the inner body part, wherein preferably said opening is provided with a stem packing. Optionally the inner body part comprises a surface that is exposed on the outside of the valve and that comprises an opening through which the stem extends. This embodiment provides an example of embodiment wherein a part but not all of the outer surface of the inner body part is covered by the outer body part.

The stem and plug are in operation in contact with process fluid and are preferably made of highly corrosion resistant steel, such as duplex stainless steel, with the same preferred materials as for the inner body part.

In embodiments wherein the valve comprises an opening for the stem, the valve typically comprises a stem packing to provide for sealing. For example a self-energizing stem packing is used.

Example materials for a self-energizing stem packing include: PTFE, PEEK, and a spring. The self-energizing stem packing comprises for instance a soft sealing, a support ring, and a spring. The spring is preferably made of stainless steel or other corrosion resistant materials.

The stem packing for instance comprises bushings and seals.

Energizing is advantageous for the seal functionality. Compared to standard sealing used, a pre-compression and a regular check of this pre-compression is not required with a self-energizing stem packing. This means that the self-energizing stem packing requires no or less periodical maintenance and minimizes the risk of leakage during valve operation.

In a preferred embodiment, the valve comprises a first opening in the inner body part and a second opening in the outer body part. The first and second opening are aligned with each other so as to allow fluid to flow between the second opening and the chamber. The opening in the inner body part and the opening in the outer body part together constitute an opening in the valve body.

Preferably the valve comprises a protective element arranged inside the second opening so as to cover the outer body part from exposure to fluid in the second opening. The protective element can also be referred to as a pipe connection piece. The protective element is for instance tubular element, preferably having a radially extending end. The tubular element is inserted through the opening in the outer body part and preferably also through the opening in the inner body part aligned with said opening in the outer body part. The preferred radially extending end of the tubular element can be used for releasably attaching the tubular element to the outer body part. The preferred radially extending end is for instance provided at the outside of the valve body. An end of the tubular element, for example the radially extending end, which is arranged at the outside of the valve body, may also provide a flange for a pipe.

The protective element is preferably releasably, e.g. detachably, attached or joined to the valve body, in particular to the outer body part. Thereby the protective element may permit for easy replacement. Removing the protective element or pipe connection piece may also permit for release of the inner body part from the outer body part.

The protective element is for instance made of duplex stainless steel, with the same preferred alloys as for the inner body part.

The valve comprises connecting means for a pipe to connect to the valve, such as for example, screws. The protective element comprises an opening for fluid flow between the pipe and the valve chamber.

The valve may comprise a sealing system for sealing the protective element to the inner body part, for instance a seal ring. The sealing ring can be e.g. a soft sealing, such as a PTFE seal ring, or a metal to metal sealing.

The protective element is e.g. screwed to the outer body part. The valve for instance comprises a locking element holding the protective element in place and being attached or joined to the outer body part, e.g. with screws.

The inner body part is for example, without restriction, made from a bar by hot working and/or cold working and optional additional heat treatment. Hot working is a process were steel is plastically deformed above its recrystallization temperature so that new strain-free grains are formed due to the combined action of load and heat. Examples of hot working processes are forging, rolling and extrusion. Cold working refers to plastically deforming a steel below the recrystallization temperature. This causes a permanent change in the steel by introducing dislocations within its structure. The steel is then work-hardened. Some methods of cold working include cold rolling, cold pilgering and cold drawing. Steels are typically heat-treated to produce a great variety of microstructures and properties. Annealing, normalizing, tempering and quenching are different types of well-known heat treatments.

Heat treatment can be used to obtain the desired mechanical properties of the inner body part as well as desired corrosion resistance properties. The relatively smaller size, in particular wall thickness (mid-wall distance), of the inner body part, compared to a unitary valve body (single valve body) for an equivalent valve, contributes to achieving proper mechanical and corrosion resistant properties by heat treatment. This applies in particular in embodiments wherein the inner body part is made of duplex stainless steel. Heat treatment of a duplex stainless steel inner body part can also be performed on a bar element with pre-drilled hole. Also for such a manufacture method, the relatively small size (mid-wall distance) of the inner body part contributes to achieving proper mechanical and corrosion resistant properties by heat treatment.

An aspect of the invention also pertains to such a method of making the inner body part. For example, there is provided a method of making an inner body part, preferably of duplex stainless steel, comprising shaping a steel object to a shaped object, heat treatment, and optional further shaping; wherein the shaped object prior to heat treatment for instance comprises a drilled hole.

Suitable stainless steel for the inner body part of the valve, and for all other components of the valve that are in contact with the fluid in operation (e.g. the stem, the plug, the valve seat, the protective element) include for example duplex stainless steel. Hence in some embodiments, all components of the valve that are in contact with the fluid in are made of stainless steel, e.g. duplex stainless steel. For example in this embodiment the outer body part is made of carbon steel.

The term ‘typically’ as used herein indicates features that are frequently used, but are not mandatory.

The term ‘duplex stainless steel’ refers to austenitic ferritic duplex stainless steel.

The term ‘fluid’ is used to include gas and liquid, as well as two-phase fluid flow. A fluid stream may comprise gas and/or liquid. A fluid stream can also be e.g. a suspension.

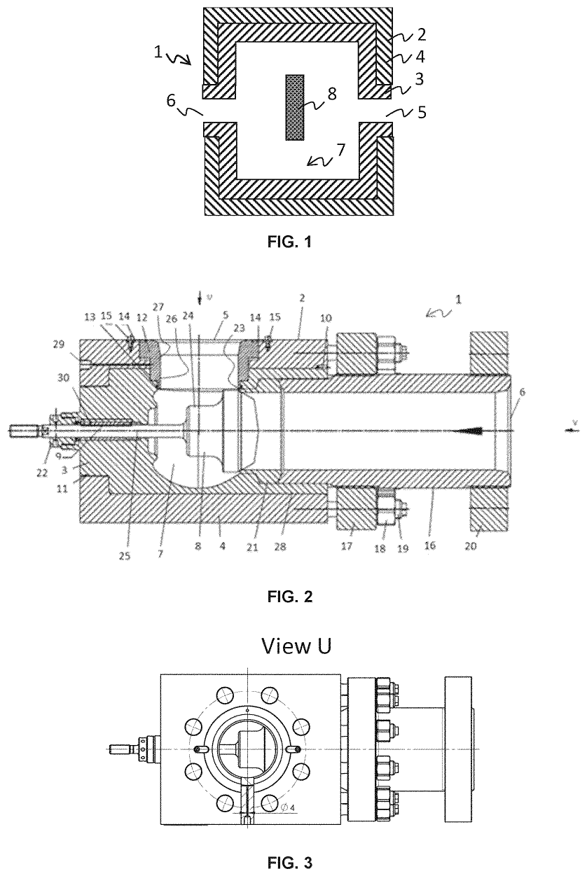

FIG. 1 schematically shows an example valve (1) according to the invention and/or as used in the invention. The valve comprises a valve body (2) with an inner body part (3) and an outer body part (4) according to the invention. The valve further comprises a first opening (5) and a second opening (6) for fluid to enter and exit the valve body, in particular to enter and exit the chamber (7) for holding fluid of the valve body. The valve also comprises a flow regulating member (8), for example a regulating stem or a disc. The flow regulating member (8) can move between at least two different positions for regulating the fluid flow. The flow regulating member (8) is at least in part located in the chamber. The flow regulating member (8) may in part extend through an opening of the valve body.

FIG. 2 shows an example valve (1) according to the invention and/or as used in the invention. The valve comprises a valve body (2) which comprises an inner body part (3) and an outer body part (4). The inner body part (3) is located in a recess (28) of the outer body part (4). The inner body part (3) and an outer body part (4) as illustrated are e.g. both single unitary pieces, e.g. of two different types of steel. The recess (28) and the outer surface of the inner body part (3) have a mating shape, as illustrated, without gaps between them.

The valve further comprises a first opening (5) and a second opening (6) for fluid to enter and exit the valve body, in particular to enter and exit the chamber (7) for holding fluid of the valve body. The flow regulating member (8) is provided as a plug (24) on a stem (25). A stem packing (9) is provided between the stem and the inner body part. The stem extends through an opening (30) in the inner body part. The stem can move in the chamber for regulating the fluid flow.

The inner and outer body parts are held in place using optional pins (10).

An O-ring (11) is located between the inner and outer body part, for example to provide a sealing against external fluids.

An opening (5) for fluid flow is provided through both the inner and outer body part (26,27). A pipe connection piece (12) provides an example protective element arranged in the opening (27) in the outer body part and, optionally, also in the opening (26) in the inner body part. Thereby the outer body part is protected against the corrosive fluid in the opening. A seal ring (13) is provided between the pipe connection piece (12) and the inner body part. The pipe connection piece (12) is connected, at the radially extending end thereof, to the outer body part using the optional plate (14) and screws (15). A pipe can be connected to the outer end of the pipe connection piece (12). The openings (26,27) in the inner respectively outer body part are aligned with each other so as to provide the opening (5) for fluid flow through the valve body.

A seat connection piece (16) is provided for holding the inner body part in place in the outer body part. The seat connection piece is attached or joined to the valve outer body part using, in this example, a seat flange (17) and bolts and nuts (18,19). The seat connection piece (16) comprises a flange (20) for connection with a pipe.

In an example embodiment, the seat connection piece (16) and seat flange (17) can be detached and the inner body part (3), being a unitary metal piece, can exit the recess (28) of the outer body part (4) through the opening in the outer body part at the side with seat flange (17) (right hand side in the figure) after removal of the pipe connection piece (12), in example embodiments wherein the pipe connection piece (12) protrudes in the opening (26) in the inner body part, and after suitable detachment of the stem (25).

The valve comprises a valve seat (21) configured for sealing contact with the regulating stem, in particular for sealing contact with the plug. The valve seat includes a notch prolongation (23) for engaging with the plug.

The regulating stem is, in this example, at one end attached to an actuator, using e.g. the screw (22). Alternatively the valve can be manually operated.

The valve also comprises a leak detection element (29). The leak detection element is optional and is a provision for detecting any leakage of fluid from the inner body part to the outer body part.

FIG. 3 shows the view U of the valve of FIG. 2.

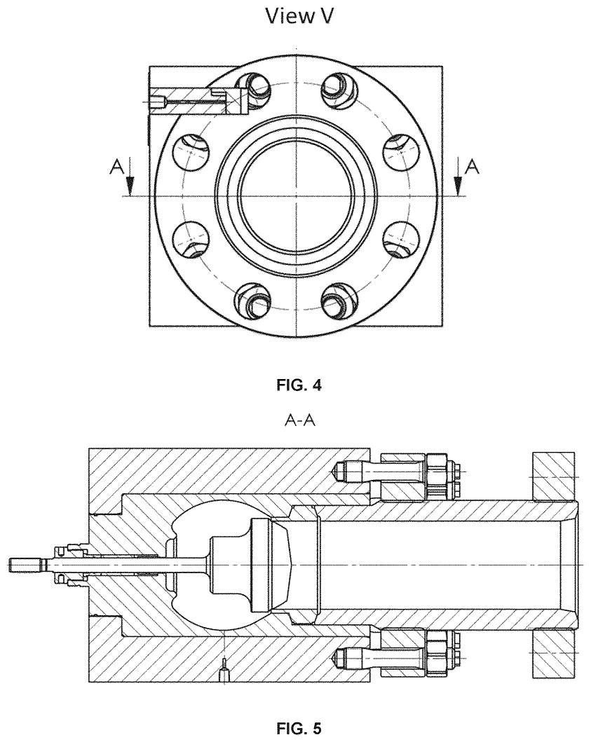

FIG. 4 shows the view V of the valve of FIG. 2.

FIG. 5 shows the view along A-A (see FIG. 4) of the valve of FIG. 2.

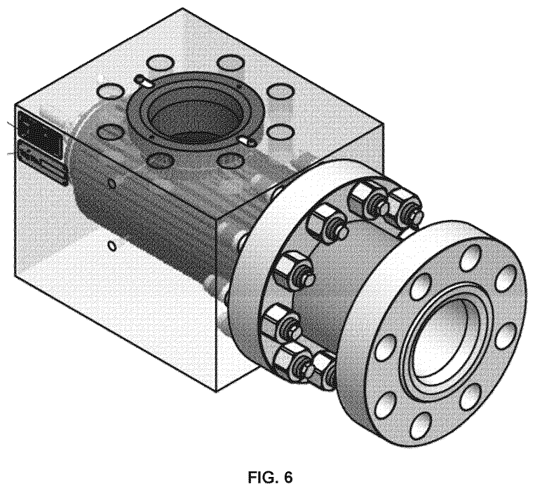

FIG. 6 shows an isometric view of the valve of FIG. 2.

1. A valve for regulating fluid flow comprising a valve body, an inlet for fluid, an outlet for fluid, a flow-regulating member, a chamber for receiving fluid in the valve body, and a valve seat, wherein the valve body comprises an outer body part and an inner body part fit together and/or mechanically joined to each other, whereby the outer body part is made of a first material and whereby the inner body part is made of a second material, wherein the first and second material are different from each other; wherein the inner body part comprises a surface exposed to said chamber and directly in contact with said fluid in the chamber in operation, wherein the inner body part is made of duplex stainless steel, and the outer body part is made of carbon steel.

2. The valve according to claim 1, wherein the inner body part is releasably held in the outer body part.

3. The valve according to claim 1, wherein the flow-regulating member comprises a regulating stem or a stem and a plug arranged for moving in the chamber between at least two different positions for regulating fluid flow; and wherein the stem extends through an opening of the inner body part provided with a stem packing.

4-13. (canceled)

14. The valve according to claim 3, wherein the stem, the plug, and the valve seat are made of duplex stainless steel.

15. The valve according to claim 1, wherein the valve seat is supported by and in direct contact with the inner body part.

16. The valve according to claim 1, wherein the valve comprises an opening in the inner body part and an opening in the outer body part, said openings being aligned with each other so as to allow fluid flow between the opening in the inner body part and the chamber; wherein the valve comprises a protective element arranged inside the opening in the outer body part so as to cover the outer body part from exposure to fluid in the opening in the outer body part, wherein the protective element optionally also extends through the opening in the inner body.

17. The valve according to claim 16, wherein the protective element is made of duplex stainless steel.

18. The valve according to claim 16, wherein the protective element is a tubular element inserted in both the opening in the inner body part and the opening in the outer body part.

19. The valve according to claim 1, comprising a seat connection piece which is attached to the outer body part by releasable connecting means and which holds the inner body part in place in a recess of the outer body part.

20. The valve according to claim 19, wherein the seat connection piece also holds the valve seat in place in the valve body.

21. The valve according to claim 1, wherein the inner body part is a sleeve that fits in the outer body part and fits through an opening in the outer body part and wherein the outer body part comprises a recess for receiving the inner body part and for releasably holding the inner body part in the outer body part.

22. The valve according to claim 1, wherein the outer body part is a single metal piece and wherein the inner body part is a single unitary part.
